(19) United States
(12) Patent Application Publication
(10) Pub. No.: US 2026/0310588 A1
(43) Pub. Date: Oct. 8, 2026

(54) Correlation-Based Testing to Validate Behavioral Phase-of-Execution Inference

(71) Applicant: Arm Limited, Cambridge (GB)

(72) Inventors: Michael BARTLING, Austin, TX (US); Brendan James MORAN, Coton (GB)

(21) Appl. No.: 19/459,795

(22) Filed: Jan. 26, 2026

Related U.S. Application Data
(60) Provisional application No. 63/783,486, filed on Apr. 4, 2025.

(51) Int. Cl. G06F 11/3668; G06F 9/54

(52) U.S. Cl. CPC G06F 11/3684; G06F 9/542; G06F 11/3672

(57) ABSTRACT

Systems and methods are disclosed for validating behavioral phase-of-execution determinations using correlation-based testing. A behavioral sensor derives behavior indicators from processor-level execution events, and a phase inference engine correlates the indicators with stored phase profiles to produce an inferred or predicted phase-of-execution together with an associated confidence value. A correlation validator evaluates the uncertainty of the inference and selectively applies validation tests that include non-intrusive consistency checks, active state-changing tests, or controlled experiments that introduce structured stimuli. Results of the applied tests are analyzed to increase or decrease the confidence value or to refine or discard candidate phases. Testing may be initiated or continued based on expected confidence improvement relative to associated cost, and may proceed iteratively while confidence remains within threshold ranges. These techniques reduce uncertainty in behavioral determinations and enable more reliable identification or prediction of phases-of-execution during program execution.

### CROSS-REFERENCE TO RELATED APPLICATIONS

This application claims the benefit of U.S. Provisional Application No. 63/783,486, filed Apr. 4, 2025, the entire contents of which are incorporated herein by reference.

### BACKGROUND

Modern processing units expose a rich stream of processor-level execution events that reflect architectural activity during program execution. These events, which may include instruction retirements, cache interactions, memory accesses, and other low-level behaviors, can vary widely depending on workload characteristics, data patterns, and execution conditions.

When behavioral information is used to guide system actions, uncertainty in the underlying behavioral signals can limit the reliability of those actions. Microarchitectural events may vary due to data dependencies, transient conditions, or other factors that obscure whether a behavioral indication truly reflects the system's operating context. As a result, there is a need for mechanisms that can reduce uncertainty by evaluating the degree to which observed behavioral indicators correlate with expected behavior. Without such mechanisms, systems may lack a structured way to assess, refine, or increase confidence in an initial behavioral determination.

### BRIEF SUMMARY

Correlation-based testing to validate behavioral phase-of-execution determinations is disclosed. In some embodiments, behavioral indicators derived from processor-level execution events are analyzed to obtain an initial phase determination together with an associated confidence value. Because architectural behavior at the processor level may vary due to transient conditions, data dependencies, or other dynamic execution factors, the initial determination may include some degree of uncertainty. A correlation validator can evaluate this uncertainty by applying one or more validation tests that examine how observed behavioral indicators align with expected behavior for a candidate phase-of-execution.

In some aspects, a method of determining a phase-of-execution of code in a processing unit, includes: receiving, via a behavioral sensor, a sequence of behavior indicators derived from processor-level events detectable at an architectural level of the processing unit during execution of the code; correlating the sequence of behavior indicators with profiles of stored execution phases using a phase inference engine to generate a phase determination together with an associated confidence value; applying, by a correlation validator, a plurality of tests responsive to the phase determination or the confidence value; and adjusting the confidence value or the phase determination based on results of the plurality of tests to reduce uncertainty.

In some aspects, a system for minimizing uncertainty when behaviorally determining a phase-of-execution, includes: a correlation validator configured to: receive, from a behavioral sensor, a sequence of behavior indicators derived from processor-level events detectable at an architectural level of the processing unit during execution of the code; access phase-correlation data including profiles of stored execution phases and a phase determination together with an associated confidence value generated by a phase inference engine; and apply a plurality of tests responsive to the phase determination or the confidence value and to adjust the confidence value or the phase determination based on results of the plurality of tests to reduce uncertainty.

In some aspects, a method of predicting a subsequent phase-of-execution of code in a processing unit, includes: inferring, from a sequence of behavior indicators derived from processor-level execution events detectable at an architectural level of a processing unit during execution of the code, a current phase-of-execution; predicting, based on the current phase-of-execution and the sequence of behavior indicators, a subsequent phase-of-execution together with an initial confidence value regarding the subsequent phase-of-execution; applying, by a correlation validator, at least one of a plurality of tests that utilize at least a portion of the sequence of behavior indicators or data derived therefrom; and responsive to results of the applied tests, adjusting the confidence value from the initial confidence value to an updated confidence value so as to reduce uncertainty in the predicting of the subsequent phase-of-execution.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an architecture for correlation-based testing to validate behavioral phase-of-execution inference.

FIG. 1B illustrates an internal configuration of the correlation validator and its interaction with a test repository.

FIG. 1C illustrates a representational schematic of a behavioral sensor for generating output including behavioral indicators.

FIG. 2A illustrates a specific implementation of a system with a behavioral sensor used to determine phase-of-execution from processing unit events.

FIG. 2B illustrates a specific implementation of the preprocessing circuitry present in some embodiments of the system of FIG. 2A.

FIG. 2C shows a schematic diagram where a machine learning (ML) profiler establishes the behavioral signatures of the profile storage medium.

FIG. 3A illustrates an example method for determining a phase-of-execution using correlation-based validation testing.

FIG. 3B illustrates an example method for predicting a subsequent phase-of-execution using correlation-based validation testing.

### DETAILED DESCRIPTION

Correlation-based testing to validate behavioral phase-of-execution inference is described. In some embodiments, behavioral indicators derived from processor-level events may be analyzed to produce an initial phase determination together with an associated confidence value. Because architectural behavior can vary during execution, this confidence value may reflect uncertainty in how well the behavioral indicators correspond to a particular phase-of-execution. To address this uncertainty, a correlation validator may perform targeted validation operations to assess whether observed behavioral conditions are consistent with expectations for one or more candidate phases.

The disclosed correlation validator is configured to apply validation tests that provide additional behavioral evidence responsive to an initial phase determination or its confidence value. These tests may include non-intrusive consistency checks, active or state-changing probes that perturb aspects of the processing unit, or controlled experiments initiated by an experimental agent to elicit behavior under known conditions. Results obtained from these validation tests can be used to increase, decrease, or otherwise adjust the confidence value of a candidate phase-of-execution, or to promote or discard candidate phases based on their correspondence with the observed behavioral responses.

In some embodiments, the correlation validator iteratively refines phase determinations by performing tests while a confidence value remains within a defined range, balancing test selection against cost or overhead constraints. Tests may be organized into classes according to complexity or resource usage, and the validator may select tests beginning with lower-cost options or according to a reinforcement-learning model trained to maximize confidence improvement for a given cost. These operations may reduce uncertainty in behavioral determinations and can provide identification or prediction of phases-of-execution, with subsequent adaptive or optimization actions optionally taken in response.

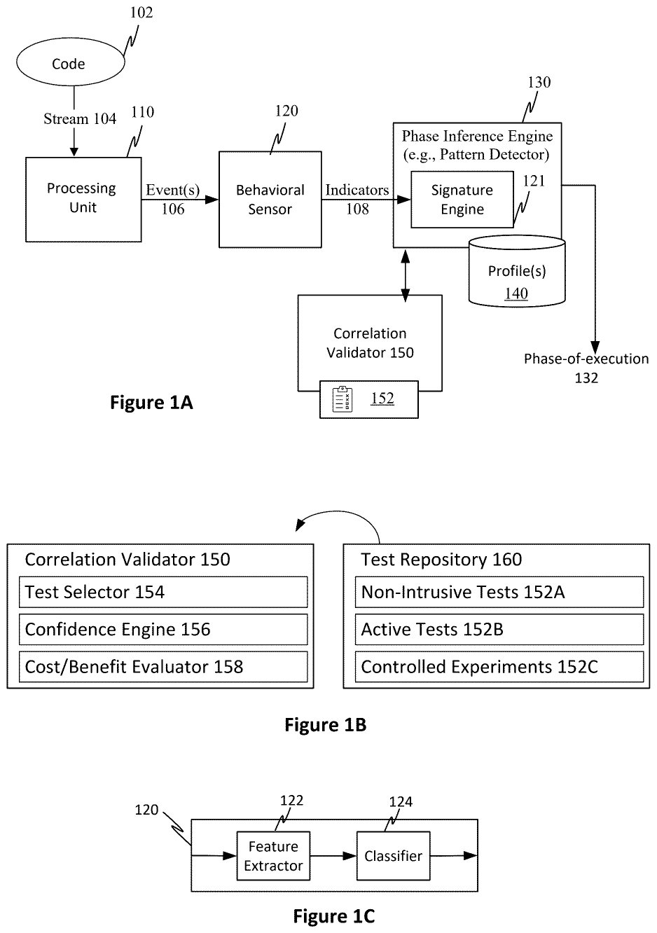

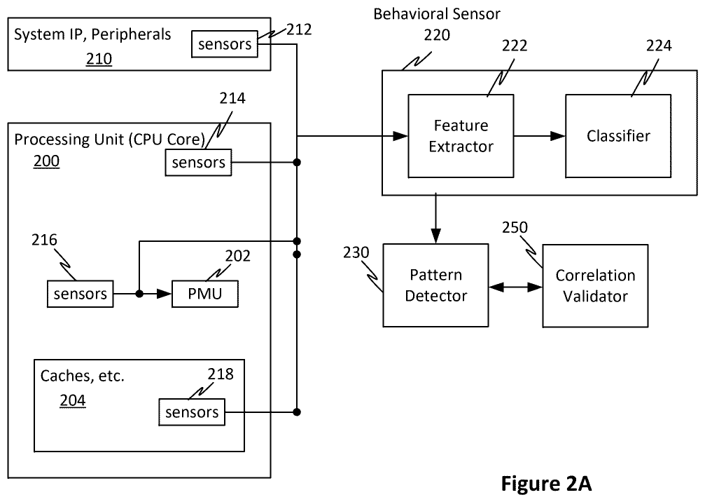

FIG. 1A illustrates an architecture for correlation-based testing to validate behavioral phase-of-execution inference. Code 102 is streamed 104 to and is executed by a processing unit 110, which results in occurrences of processor-level execution events 106. A behavioral sensor 120 observes these events and derives behavior indicators 108 that capture salient aspects of execution behavior at the architectural level. The indicators 108 are provided to a phase inference engine 130, which includes a signature engine 121 configured to construct one or more observed behavior signatures and to pattern-match them against stored profiles 140. These profiles 140 represent a catalog of known phases-of-execution, allowing the phase inference engine 130 to output an inferred phase-of-execution 132 for the running code stream. In some embodiments, the inference engine 130 operates in near real time, such that the inferred phase can be acted upon before a subsequent phase transition occurs. Generally, the phase inference engine 130, which can be referred to as a pattern detector, produces an inferred phase-of-execution 132 in a manner that enables tuning or optimization actions that improve processing unit 110 performance without incurring overhead that would negate the benefit. The system of FIG. 1A can operate in a platform-independent manner performed without assumptions about or reliance on the codebase structure.

To evaluate or refine the inferred phase-of-execution 132, the architecture further includes a correlation validator 150 configured to apply one or more validation tests 152 responsive to the inferred phase or its associated confidence value. The validator 150 may access the behavior indicators 108, intermediate correlation information produced by the phase inference engine 130, or both, and may initiate validation operations designed to determine whether observed behavioral conditions align with expected behavior for the candidate phase. Results of the tests 152 can be used to increase, decrease, or otherwise adjust the confidence value associated with the inferred phase-of-execution 132, or to promote or discard candidate phases, thereby reducing uncertainty in the inference process. In some embodiments, the validation tests 152 include non-intrusive consistency checks, active state-changing probes, or controlled experiments performed as part of validator-initiated behavioral testing. These operations allow the system to provide more reliable phase determinations without relying on assumptions about the underlying software structure.

FIG. 1B illustrates an internal configuration of the correlation validator 150 and its interaction with a test repository 160. In this embodiment, the validator 150 receives an inferred phase-of-execution together with an associated confidence value and determines whether additional behavioral evidence should be obtained to reduce uncertainty. The validator 150 may maintain multiple candidate phases concurrently, each with a respective confidence value, and may apply validation testing to promote certain candidates, refine their confidence values, or discard candidates that fail to match observed or experimentally elicited behavior. More generally, the validator 150 provides a structured mechanism for evaluating how well an inferred behavioral condition corresponds to expected execution behavior.

In some embodiments, the validator 150 includes a test selector 154 for choosing among different classes of validation tests, a confidence engine 156 for adjusting confidence values based on test outcomes, and a cost/benefit evaluator 158 configured to determine whether the expected improvement in confidence justifies performing one or more validation tests.

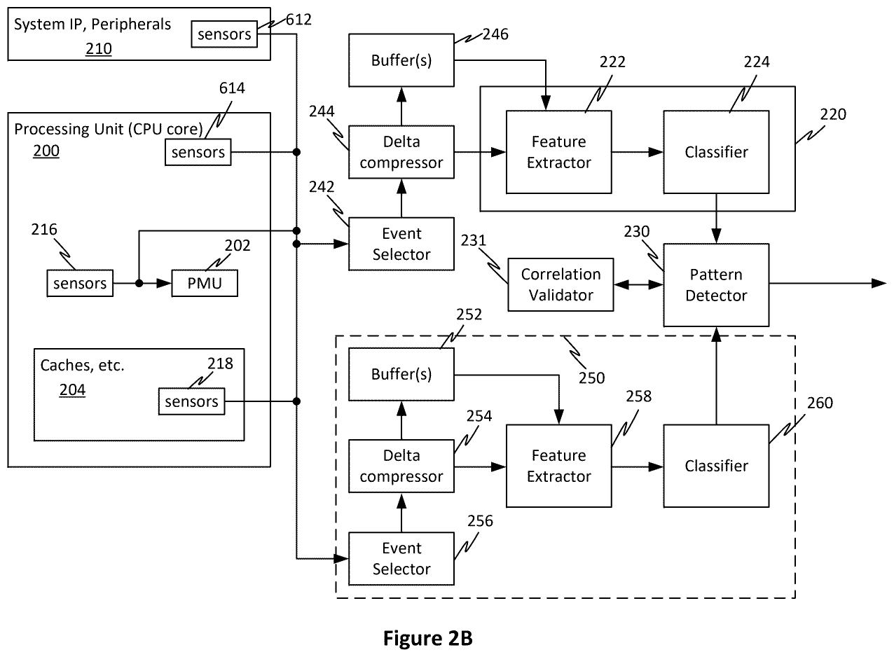

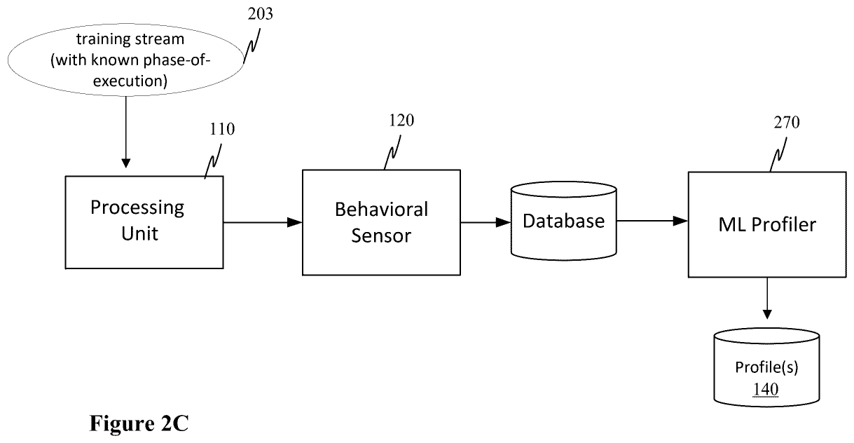

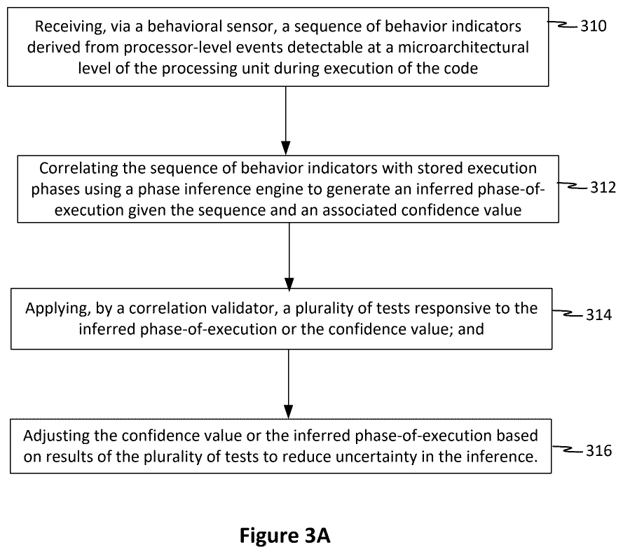

In some embodiments, the test selector 154 evaluates the current confidence value, the degree of uncertainty in the inferred phase, and information provided by the cost/benefit evaluator 158 to determine whether testing should proceed and, if so, what type of test to apply. The selector 154 may consider factors such as the magnitude of the confidence gap between the current value and the target threshold, the stability or volatility of the incoming behavioral indicators 108, and the historical effectiveness of particular test types for the phase under evaluation. By using these inputs, the test selector 154 identifies a validation action that is likely to reduce uncertainty without imposing unnecessary overhead. In some cases, the selector 154 may choose a low-cost, non-intrusive test to confirm stability of the inference, while in other cases the selector may escalate to more discriminative but higher-cost tests—such as active tests or controlled experiments—when the anticipated confidence improvement justifies the additional resource usage. In this way, the test selector 154 dynamically balances validation accuracy with operational efficiency. Specific types of tests selectable by the test selector 154 include non-intrusive tests 152A, active state-changing tests 152B, and controlled experiments 152C. In certain embodiments, statistics or priors produced by a machine-learning profiler, such as the ML profiler 270 described with reference to FIG. 2C, provide the historical effectiveness information used by the test selector 154 to guide these choices.

Non-intrusive tests 152A evaluate consistency of naturally occurring behavior indicators 108 without modifying the execution conditions of the processing unit 110. In some embodiments, these tests analyze temporal ordering, event frequency patterns, correlation strengths, or signature-matching stability to determine whether the currently inferred phase-of-execution remains consistent with observed behavior. Because non-intrusive tests rely exclusively on existing behavioral data, they can be applied with minimal overhead and may be selected when the cost/benefit evaluator 158 determines that only low-impact validation actions are justified.

Active state-changing tests 152B perturb selected portions of the processing unit state to elicit additional behavioral responses relevant to phase validation. Such perturbations may involve modifying cache usage patterns, adjusting branch-prediction resources, inducing lightweight pipeline pressure, or applying small memory-latency disturbances. The resulting altered behavior indicators can reveal whether the candidate phase exhibits expected behavioral shifts under these perturbations. Because active tests introduce measurable but controlled state changes, they may be selected when greater discriminatory power is desired and the anticipated confidence improvement justifies moderate testing cost.

Controlled experiments 152C apply a structured, validator-initiated stimulus to hardware components to elicit a predictable behavioral response that can be directly compared against expected patterns for a candidate phase-of-execution. In some embodiments, a controlled experiment may involve executing a small diagnostic instruction sequence, issuing a calibrated memory probe, injecting a synthetic micro-workload fragment, or applying a known access pattern designed to generate characteristic event signatures. The correlation validator 150, acting as an experimental agent, measures the resulting behavioral indicators and compares them with the expected response pattern for the phase under evaluation. Controlled experiments may provide relatively strong discriminatory evidence and can be selected when higher-confidence validation is desirable or when other test classes yield inconclusive results.

The confidence engine 156 processes the results of selected validation tests and adjusts the confidence values associated with candidate phases-of-execution. In some embodiments, the confidence engine 156 applies threshold-based logic that initiates or continues validation testing only while a confidence value lies between a minimum confidence threshold and a target confidence threshold. Test outcomes may increase or decrease the confidence value based on how closely the observed or experimentally elicited behavior matches the expected behavior for the candidate phase. When iterative testing increases the confidence above the target threshold, the confidence engine 156 can signal that the corresponding phase-of-execution is validated and available for selection. Conversely, when the adjusted confidence value falls below the minimum threshold, the confidence engine 156 may signal that the candidate phase is not retained for further consideration. In this way, the confidence engine 156 allows the validator 150 to refine behavioral determinations incrementally while preventing over-testing or reliance on weak candidates.

The cost/benefit evaluator 158 determines whether validation testing is justified at a given point in time based on an expected improvement in confidence relative to the anticipated cost or overhead of performing the test. By providing a cost-aware gating function, the cost/benefit evaluator 158 is configured to keep validation activity both efficient and proportional to the potential improvement in behavioral certainty.

### Cost-Benefit Calculation Methodology

In some embodiments, the cost/benefit evaluator 158 determines whether a validation test should be performed by assessing the expected improvement in confidence relative to the computational expense of executing the test. The evaluator 158 may estimate test cost by considering factors such as processor cycles consumed during test execution, temporary performance impact, cache or memory disruption, and general resource usage. These estimates may be based on lightweight measurements collected during normal operation, enabling the evaluator to approximate how much overhead a particular test is likely to introduce under current system conditions.

The evaluator 158 may estimate expected benefit by analyzing how a selected test is likely to affect the confidence value associated with a candidate phase-of-execution. This can include considering the present confidence gap relative to a target threshold, the historical effectiveness of the test type for similar behavioral conditions, and the expected discriminative power of the test. In some embodiments, the evaluator may consider how strongly the test result is expected to confirm or contradict the current inference, allowing the validator 150 to prioritize tests offering the greatest potential for reducing uncertainty.

Test selection may proceed by comparing the estimated confidence improvement against the calculated cost, such that tests are initiated only when the anticipated benefit exceeds a predetermined or dynamically determined threshold. The evaluator 158 may further adjust these cost and benefit estimates based on the current workload, system utilization, or the urgency of the phase determination being made. In this way, the cost/benefit evaluator 158 provides a structured framework for ensuring that validation tests are deployed efficiently and in proportion to their expected value, allowing the system to balance accuracy with runtime overhead.

### Test Class Organization and Tiering

In some embodiments, the validation tests accessible to the validator 150 are organized into tiered classes that reflect their expected cost, overhead, and discriminatory capability. Non-intrusive tests 152A may occupy a lower tier due to their minimal performance impact and reliance solely on naturally occurring behavioral indicators. Active tests 152B may occupy a middle tier, offering increased evidentiary strength at the cost of localized perturbations to system state. Controlled experiments 152C may be placed in a higher tier due to their structured nature and stronger influence on microarchitectural activity. Tiering is not restricted to the class of tests, but can also reflect other factors, such as processing cost/overhead, intrusiveness, and the like. In some instances, for example, a set of non-intrusive tests 152A can be more costly than some controlled experiments 152C, just as some active tests 152B may be less costly than some non-intrusive tests 152A, and tiers based on costs can categorize these tests accordingly.

The tiered organization enables the validator 150 to escalate validation activity in a deliberate fashion, beginning with low-impact checks and progressing toward stronger tests only when warranted. This tiering also supports adaptive testing strategies in which the validator avoids unnecessary overhead when confidence is already high or when uncertainties can be resolved using lower-tier tests.

### Iterative Test Selection and Termination Logic

Validation may proceed iteratively while a confidence value for a candidate phase-of-execution lies between a minimum confidence threshold and a target confidence threshold. After each test, the confidence engine 156 may evaluate the updated confidence value and determines whether the candidate phase has been sufficiently validated, requires further evidence, or should be discarded. The iterative process allows incremental refinement of behavioral certainty over time rather than relying on a single test outcome. This prevents premature acceptance of weak candidates and avoids unnecessary testing once a high-confidence conclusion has been reached. In addition, the cost/benefit evaluator 158 may terminate testing when the anticipated improvement in confidence no longer justifies the overhead associated with additional tests or when the available test classes would impose excessive disruption relative to the remaining uncertainty. This iterative and cost-aware termination logic, which is present in some implementations, enables efficient convergence on reliable phase determinations with controlled resource usage.

### Perturbations and Active Tests

Active state-changing tests 152B introduce controlled perturbations to selected microarchitectural components of the processing unit. These perturbations may slightly alter cache residency patterns, adjust branch-prediction parameters, introduce limited pipeline pressure, impose modest variations in memory-access timing, or effectuate some other architectural change. The resulting changes are small enough to avoid disrupting the overall execution flow but sufficient to reveal how the candidate phase responds to shifts in resource behavior. For phases characterized by distinct cache-miss patterns, branch-resolution behavior, or memory-latency sensitivity, these perturbations can expose confirming or disconfirming behavioral signatures. Active tests therefore provide a balance between low-overhead non-intrusive checks and the more structured controlled experiments, offering mid-tier discriminatory strength. The validator 150 may select these perturbations when moderate uncertainty remains and when the expected confidence gain justifies introducing measured, temporary changes to the execution environment.

### Experimental Agents and Controlled Experiments

In some embodiments, the correlation validator 150 operates as an experimental agent (or employs one or more experimental agents) by initiating controlled experiments to obtain additional behavioral evidence relevant to a candidate phase-of-execution. A controlled experiment is a directed action that applies a structured or calibrated stimulus to the processing unit 110, such as issuing a diagnostic instruction pattern, generating a synthetic micro-workload fragment, or performing a targeted memory probe with known access characteristics. These stimuli are selected to elicit behavioral responses that exhibit predictable features for certain phases-of-execution, allowing the validator 150 to compare the resulting behavior indicators against expected patterns stored in the phase profiles 140. Controlled experiments generally provide high discriminatory value and may be invoked when other test classes yield inconclusive results or when the confidence engine 156 indicates that a greater improvement in certainty is required before selecting or discarding a candidate phase. In this manner, controlled experiments allow the validator to create well-defined behavioral conditions that can clarify ambiguous or low-signal inference scenarios.

In some embodiments, the correlation validator 150 operates not only as a passive consumer of behavioral evidence but as an active experimental agent capable of planning and sequencing validation actions. The validator 150 may determine an appropriate experimental strategy based on current uncertainty, the characteristics of the candidate phase, and historical effectiveness of different test classes. For example, the validator may initiate a preliminary probe to gather coarse-grained behavioral feedback before issuing a more discriminative or targeted experiment. The experiments may be structured into single-step or multi-step sequences in which each step provides intermediate evidence that informs the next validation action. This agent-like behavior allows the validator 150 to gather behavioral signals in a deliberate and adaptive manner, improving confidence refinement while minimizing unnecessary testing overhead.

As used herein, code 102 represents any software, firmware, or instruction sequence executed by the processing unit 110. In some embodiments, code 102 may include application software, kernel-level code, library functions, or firmware routines. The execution stream 104 refers to the dynamic flow of code on the processing unit 110, observed as processor-level execution events generated at the microarchitectural level, such as instruction retirements, cache accesses, branch predictions, or memory requests. Order and timing sequences of processor-level events resulting from the flow can be significant. In some embodiments, these events are collected as a continuous trace, while in other embodiments they may be sampled to form a representative sequence.

The processing unit 110 may include one or more processor elements, such as a central processing unit (CPU), graphics processing unit (GPU), microcontroller, or specialized computing element (e.g., a multiplier-accumulator (MAC) unit with memory). In some embodiments, the execution stream is captured as discrete events, rather than as aggregated samples, to preserve timing fidelity.

The execution events 106 can include processor-level events detectable at the microarchitectural level of the processing unit 110. Such events may be generated, for example, by a performance monitoring unit (PMU) or other functional components of the processor microarchitecture, including branch predictors, caches, execution pipelines, prefetchers, memory controllers, and translation lookaside buffers (TLBs). The events can capture both positive outcomes (e.g., an instruction retired, a store completed, a cache hit) and negative outcomes (e.g., branch misprediction, cache miss, TLB miss, pipeline stall). In some embodiments, the events 106 may further include timing information or counts, such as cycles elapsed between events or event frequency, which can be used to characterize execution behavior. Collectively, these processor-level events 106 form the raw behavioral signal from which indicators 108 are derived.

The behavioral sensor 120 converts the raw execution events 106 into behavior indicators 108, which may encode both the occurrence of local events and their relative timing. A sequence of such indicators provides higher-level information that the phase inference engine 130 can use for signature matching. In some embodiments, the behavior indicators 108 can be considered ‘consumable events’ as described in U.S. Pat. No. 12,147,326, titled Behavioral Sensor for Creating Consumable Events. That disclosure illustrates one particular embodiment of a behavioral sensor, in which raw processor-level events are transformed into standardized, consumable indicators suitable for downstream analysis. The present behavioral sensor 120 encompasses such embodiments, as well as other mechanisms that derive structured, higher-level indicators from the microarchitectural event stream.

Behavioral indicators 108 are derived signals that abstract raw execution events 106 into higher-level representations of processing unit behavior. For example, an individual indicator may encode the occurrence of a cache miss, a branch misprediction, or a retired instruction, as well as the relative timing between such events. A sequence of behavioral indicators 108 thus captures meaningful execution patterns at the microarchitectural level, providing a compact and consumable representation of the workload's behavior for further analysis.

Phase inference engine 130, which can also be referred to as a pattern detector, consumes the behavioral indicators 108 and identifies phases-of-execution based on these inputs. In some embodiments, the phase inference engine 130 includes a signature engine 121 that constructs observed behavior signatures from the incoming behavioral indicators 108 and pattern-matches them against a catalog of stored profiles 140 representing known execution phases. A behavior signature is a structured representation of an execution phase, defined by a specific sequence or arrangement of behavioral indicators 108. In practice, a behavior signature need not correspond to a complete sequence of events; rather, it may capture characteristic patterns that provide a statistical likelihood of correspondence to a given phase-of-execution. Each such signature reflects the characteristic microarchitectural activity of a phase-of-execution and can be stored in the profile storage medium for later comparison against observed sequences.

Based on this comparison, the phase inference engine 130 outputs at least one phase-of-execution 132, optionally accompanied by a confidence value. The confidence value may increase as additional matching signatures are observed, and may also be refined using contextual information such as the identity of preceding phases (since certain phases are more likely to follow others). In this way, probabilistic modeling can reinforce or refine the inference over time, improving the likelihood of correct detection. In some embodiments, behavior signatures are established or refined using machine learning techniques, and the inference engine may further employ fuzzy logic or state-machine approaches. The inference engine 130 may be realized in hardware (e.g., logic gates, ASIC) or software executed by a processor (either the same processing unit 110 or a different one). In certain embodiments, the inference engine 130 operates in near real time, enabling optimizations or tuning actions to be performed before a subsequent phase transition occurs. As used herein, the confidence value is a measure of how certain the inference engine is that a detected behavior signature corresponds to a particular phase-of-execution.

In some embodiments, the phase profiles 140 may be refined using iterative or feedback-based learning mechanisms. For example, discrepancies between expected behavioral patterns and those observed during operation may trigger refinement of the corresponding profile or adjustment of its confidence-weighting parameters. In certain implementations, generative or reconstruction-based models may be used to detect deviations or to update the characteristic signatures associated with a phase. This iterative feedback process allows the system to maintain accurate and robust phase representations even as workloads evolve or as code paths change over time.

As used herein, a phase-of-execution 132 refers to a relatively high-order stage of program behavior that persists over a region of execution and is distinguishable by characteristic patterns of processor-level execution events. For example, phases 132 may correspond to algorithmic regions (e.g., compression vs. coding), functional modes (e.g., initialization, steady-state operation, cleanup), or other segments of execution that exhibit repeatable microarchitectural behavior. Each phase-of-execution 132 typically engages processor resources in a distinct way—such as exercising caches, branch predictors, or memory pipelines differently from other phases—and can therefore be selectively optimized or tuned. By identifying these phases 132 dynamically, the processing unit 110 can apply targeted optimizations that would not be possible under a non-differentiated workload view, where execution is treated as homogeneous and resource usage patterns are obscured.

FIG. 1C illustrates a representational schematic of a behavioral sensor 120 for generating output including behavioral indicators 108. In this embodiment, the behavioral sensor 120 includes a feature extractor 122 and a classifier 124. The feature extractor 122 is coupled to the processing unit 110 (or another device) to receive a stream 104 of processor-level execution events 106 generated during execution of code 102. The feature extractor 122 identifies salient features of individual events in the stream and associates them with timing information. In some embodiments, a buffer (not shown) is used to capture the event stream prior to feature extraction, while in others the feature extractor 122 is robust enough to directly process events arriving from a processor trace or PMU interface. The feature extractor 122 operates to identify salient characteristics from the event stream, while the classifier 124 assigns identified features to categories representing different behavioral indicators 108.

The feature extractor 122 may be implemented as, for example, a programmable binary state machine, a binary pattern matching engine, a bitstream pattern matcher, a path signature extractor, digital filter, statistical calculator, or other suitable circuitry (including more complex circuitry with or without acceleration). A programmable binary state machine examines events bit by bit, traversing defined states to identify one or more features. A bitstream pattern matcher compares larger fields of an event record (or even the entirety of the record) against predefined patterns. A path signature extractor applies high-dimensional analysis to a sequence of events to derive a unique signature of a path or behavior segment.

As noted, the feature extractor 122 associates each event with timing information. The extracted features may correspond to events of interest such as PMU-monitored outcomes (e.g., branch mispredict, load retired, store retired, branch retired, cache miss). Timing may be measured using a counter within the behavioral sensor 120 or externally by the processing unit 110. The time can be absolute (e.g., wall-clock values such as second, minute, hour, date) or relative (e.g., cycle differences between consecutive events). In one embodiment, relative time is compressed using delta values, optionally with a ceiling value (e.g., 1,000 cycles) enforced by a saturating counter to avoid unbounded representations.

The classifier 124 receives the features identified by the feature extractor 122 and assigns them to one or more predefined categories that correspond to behavioral indicators 108. Classification may include assignment of a confidence measure, rather than binary membership, quantizing the degree of fit (e.g., on a scale of 0-255). The resulting classified events, together with their associated timing, form a temporal series of behavioral indicators 108 that can be consumed by the phase inference engine 130. In some embodiments, the classifier 124 outputs labeled vectors representing values for a subset of categories. Suitable classifier types include nearest-neighbor or approximate-nearest-neighbor classifiers, decision trees, support vector machines, gradient-boosted models (e.g., XG-Boost), or other machine learning techniques. In other embodiments, classifier 124 may employ behavioral locality-sensitive hashing (bLSH) for approximate similarity matching.

In certain embodiments, the labels output by the classifier 124 may be arbitrary in the sense that they are chosen for convenience or design preference rather than inherent necessity. For example, labels may have semantic meaning to a program (e.g., unique identifiers for hashes of basic blocks), may be hand-crafted for known behaviors, or may be learned automatically in an unsupervised or semi-supervised manner. Generally, the phase inference engine may operate regardless of whether it was trained in supervised, unsupervised, or semi-supervised modes, enabling adaptive labeling and inference across varying availability of labeled data.

While classifier labels can be used directly for training phase inference models, alternatives are contemplated. For instance, intermediate embeddings may be produced that project dynamic features into a space that preserves similarity. Such embeddings can accelerate training convergence for complex phase detection models and facilitate knowledge transfer across machine learning tasks.

Although FIG. 1C depicts a behavioral sensor 120 with only a feature extractor 122 and classifier 124, alternative implementations may include additional circuitry or subsystems, such as those described in connection with FIGS. 2A and 2B. In some cases, intermediate values from the feature extractor 122 may be exported or made observable, enabling hybrid or multi-stage analysis pipelines.

In further embodiments, waypoints and hints can be employed to augment operation of the feature extractor 122 and classifier 124. Waypoints represent specific milestones or markers injected into a program's execution path, while hints comprise contextual information or annotations (such as compiler-inserted signals) that provide additional guidance. These can assist the classifier in recognizing intent or higher-level program structure. For example, a compiler could inject dummy instructions each time a data stream requires sorting, providing a waypoint detectable by the behavioral sensor 120. In some embodiments, hints may be detected by auxiliary sensors such as sensors 212, 214, 216, or 218 shown in FIG. 2A.

FIG. 2A illustrates a specific implementation of a system with a behavioral sensor used to determine phase-of-execution from processing unit events. Referring to FIG. 2A, a computing system can include a processing unit 200, such as a CPU core, system interfaces and peripherals 210. The processing unit 200 can include a performance monitoring unit (PMU) 202 and memory 204. The processing unit 200 can execute commands/instructions stored in the memory 204. As commands/instructions are performed, certain activities, operations, and behaviors at the processing unit 200 and the system interfaces and peripherals 210 may be considered events.

A number of sensors can be distributed throughout the computing system to detect various events and states. For example, one or more sensors 212 can be located at the system interfaces and peripherals 210, one or more sensors 214 can be located at the processing unit 200, one or more sensors 216 can be for monitoring by the PMU 202, and one or more sensors 218 can be located associated with memory 204 (e.g., caches and memory management, etc.). In the illustrated scenario a behavioral sensor 220 is included to create behavioral indicators from the events (e.g., processing unit events) detected by the various sensors 212, 214, 216, 218 for a pattern detector 230 (e.g., phase inference engine 130) used for determining phase-of-execution.

Behavioral sensor 220 includes feature extractor 222 and classifier 224, which can be configured as described with respect to the behavioral sensor 120 of FIG. 1B. Preprocessing circuitry can be included (and considered part of behavioral sensor 220 or part of the coupling circuitry to the processing unit 200).

FIG. 2B illustrates a specific implementation of the preprocessing circuitry present in some embodiments of the system of FIG. 2A. The preprocessing circuitry can include an event selector 242, a cycle delta compressor 244, and one or more buffers 246. Of course, certain embodiments may omit one or more of these circuit elements and certain embodiments may include additional circuit elements in addition to or in place of the event selector 242, cycle delta compressor 244, and one or more buffers 246.

The event selector 242 can receive input of events of the event stream from one or more sources (e.g., from any of sensors 212, 214, 216, 218) and selects events based on one or more criteria. The criteria can include type of processor commands, number of cycles, or other predefined constraints. The event selector 242 is used to constrain the complexity of the feature extractor 222 so that the feature extractor 222 works from a subset of signals. That is, the event selector 242 provides a reduced event stream to the feature extractor 222. The event selector 242 can be embodied as a multiplexor, wherein a select line of the multiplexor can determine whether to allow an event on a bus line of the multiplexor to pass. The select pin can be controlled externally, for example by a processor that only allow certain events to pass. In other instances, the select pin can be coupled to a particular sensor or PMU to only allow events from particular sources. In other cases, a particular bit of the event can be fed to the select pin (e.g., an event comprising of seven bits can include six bits of data about the event and one bit that is used as a flag). In another implementation, the event selector can be a bit-mask that merges multiple sources of events into a single bitstream (e.g., combining loads and stores into a single “load or store” event).

The cycle delta compressor 244 can be used when relative time is used as the time value in the time series to determine the number of cycles between valid events. Because CPUs do not generate events on every cycle, the delta compressor 244 can be used to compress 0-space with run-length-encoding. That is, the delta compressor 244 can count the number of empty samples and save this delta as the cycle delta from the previous non-empty sample. In this manner, the cycle delta compressor 244 generates a count of a number of empty cycles between events of the event stream. The delta compressor 244 can include a counter (e.g., in the form of a number of flip-flops connected in cascade). The counter can be regularly incremented, for example by a clock circuit. When a valid event is received, the counter can be read and the value (that is the differential in time between two valid events) can be stored as the time and forwarded with the event. The counter can then be reset. In some cases, the counter used in the delta compressor 244 can be a saturating counter, wherein a ceiling value is included, beyond which the counter cannot increment. For example, the ceiling value can be 1,000 cycles—if an event were to occur more than 1,000 cycles after an immediately previous valid event, then a value of 1,000 cycles can be assigned as the time despite the actual number of cycles being greater than 1,000.

The one or more buffers 246 can serve to slow down receipt of events. In some cases, events are produced at a greater rate than can be processed by the feature extractor 222 or classifier 224. To prevent these events from being discarded or conflicting with events currently being processed, a buffer 246 can be used to store events until the feature extractor 222 or classifier 224 are ready. The buffer 246 can be, for example, a digital buffer, storage resource, static random-access memory (SRAM), or flip-flop circuit. In some cases, the buffer 246 automatically pushes received events to the feature extractor 222, and, in other cases, the buffer 246 receives a signal from the feature extractor 222 or the classifier 224 that indicates that the previous event has been processed by one or both of the feature extractor 222 and the classifier 224. In some cases, there may be an additional buffer between the feature extractor 222 and the classifier 224.

Additional event collection systems 250 can be included as part of the system (with consumable events provided to the pattern detector 230), each including their own buffers 252, cycle delta compressor 254, event selector 256, feature extractor 258, and classifier 260.

Pattern detector 230 (e.g., phase inference engine 130) can be considered a security system such as described in FIG. 1A. In some cases, pattern detector 230 can be a higher order machine learning or statistical system implemented, for example, with neural networks, deep learning techniques. Pattern detector 230 can perform high-level decisions on mitigation and reporting.

FIG. 2C shows a schematic diagram where a machine-learning (ML) profiler 270 establishes behavioral signatures for the profile storage medium. Generally, a training stream 203 having a known phase-of-execution is conveyed to the processing unit 110, and the behavioral sensor 120 produces sequences of behavioral indicators from processing unit events. These sequences can be stored for offline or online training. In some embodiments, training data is generated by replaying known executions through the behavioral classifiers or by sampling real data from the field, optionally sanitized before use. The ML profiler 270 discovers patterns in the sequences and creates signatures indexed to known phases-of-execution, improving signature distinctiveness as more diverse training streams 203 are incorporated.

The ML profiler 270 may employ supervised, unsupervised, or semi-supervised techniques, including clustering methods, autoencoder-based representations, or other statistical or neural models to map behavioral indicators into an internal phase-of-execution state space. For example, graph-based models or graph autoencoders may learn typical transition structures between internal states, with persistent deviations or high reconstruction error indicating anomalous or unexpected execution behavior. Generative or feedback-based training loops, such as those used in generative adversarial networks (GANs) or related semi-supervised frameworks, may be used to improve model robustness, and approximate nearest-neighbor search can assist in clustering and labeling large behavioral datasets. These mechanisms collectively enable efficient learning of phase signatures and transition patterns from unlabeled or partially labeled training data.

Because behavioral indicators form time-ordered sequences, the ML profiler 270 may also employ sequence models to interpret or classify behaviors over windows of execution. In different embodiments, transitions may be modeled using graph structures and graph neural networks, convolutional neural networks applied over temporal windows, attention-based models such as transformers, or recurrent neural networks (RNNs) suited for time-series analysis. In some cases, a larger or more expressive model is trained first and then distilled to a smaller model using teacher-student techniques to reduce deployment cost. These modeling options are illustrative rather than limiting; any suitable learning architecture that can map behavioral sequences to internal phase-of-execution representations or transition structures may be used.

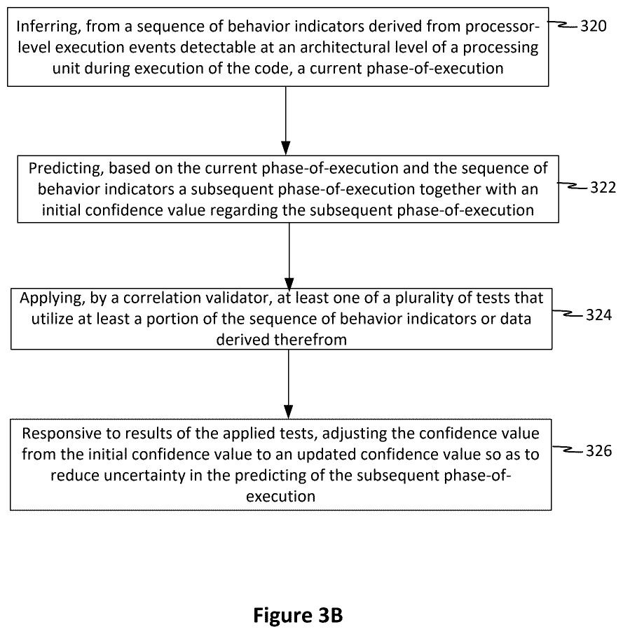

FIG. 3A illustrates an example method for determining a phase-of-execution using correlation-based validation testing. At step 310, a sequence of behavior indicators is received via a behavioral sensor. The indicators are derived from processor-level execution events detectable at a microarchitectural or architectural level of the processing unit while executing code. These indicators provide a structured representation of execution behavior suitable for correlation and pattern analysis.

At step 312, the sequence of behavior indicators is correlated with profiles of stored execution phases using a phase inference engine. The inference engine generates an inferred phase-of-execution together with an associated confidence value based on how closely the incoming indicators match one or more behavior signatures or profiles. The inferred phase and confidence value represent an initial behavioral determination that may include uncertainty due to variations in workload, data conditions, or microarchitectural dynamics.

At step 314, a correlation validator applies one or more validation tests responsive to the inferred phase-of-execution or its confidence value. These validation tests may include non-intrusive tests, active state-changing tests, or controlled experiments, each configured to generate additional behavioral evidence that informs the correctness or reliability of the inference. The choice of test may depend on factors such as the magnitude of uncertainty, confidence thresholds, anticipated test cost, or historical effectiveness of test types for the phase under evaluation.

At step 316, the confidence value or inferred phase-of-execution is adjusted based on results of the applied tests. The correlation validator may increase, decrease, or otherwise refine the confidence value according to the degree of correspondence between expected behavior and the observed behavioral responses generated during testing. By selectively applying validation tests and updating the inference accordingly, the method reduces uncertainty and yields a more reliable phase-of-execution determination.

In some embodiments, the plurality of tests are organized into classes tiered according to cost, and the correlation validator initiates testing within a selected class beginning with lower-cost tests whose cumulative cost is limited relative to an anticipated benefit from reducing uncertainty.

In certain embodiments, the correlation validator is configured to initiate and iteratively repeat the applying of the plurality of tests while the confidence value is between a minimum confidence threshold and a target confidence threshold, to cease testing when the confidence value exceeds the target confidence threshold or falls below the minimum confidence threshold, and to discard a candidate phase-of-execution from consideration when the confidence value falls below the minimum confidence threshold.

FIG. 3B illustrates an example method for predicting a subsequent phase-of-execution using correlation-based validation testing. At step 320, a current phase-of-execution is inferred from a sequence of behavior indicators derived from processor-level execution events detectable at an architectural or microarchitectural level of a processing unit during execution of code. The current phase inference may be accompanied by a confidence value indicating the strength of the correlation between the observed indicators and stored profiles of known execution phases.

At step 322, a subsequent phase-of-execution is predicted based on the current phase-of-execution and the ongoing sequence of behavior indicators. The prediction may include generating an initial confidence value that reflects the likelihood that the subsequent phase will occur next in the execution stream. In some embodiments, the prediction accounts for expected phase-transition patterns, historical correlations between phases, or temporal/behavioral features derived from the indicator sequence.

At step 324, a correlation validator applies at least one validation test selected from a plurality of available test types. These tests may utilize portions of the behavioral-indicator sequence, features derived from the indicator sequence, or behavioral responses obtained during active or controlled validation operations. The selected test is responsive to the predicted subsequent phase-of-execution or its initial confidence value, and is intended to gather additional behavioral evidence relevant to the correctness of the prediction.

At step 326, the validator adjusts the confidence value associated with the predicted subsequent phase-of-execution based on the results of the applied test. The confidence may be increased when observed behavioral evidence aligns with expected patterns for the predicted phase, or decreased when inconsistencies are detected. By iteratively applying validation tests and updating the confidence value, the method reduces uncertainty in the prediction of the subsequent phase-of-execution and provides a more reliable forward-looking behavioral determination.

In certain embodiments, portions of the behavioral sensor, signature construction, and inference logic execute in firmware or hardware positioned proximate to microarchitectural telemetry sources (e.g., a PMU, trace fabric, or other on-die observability interfaces) to meet latency targets, while catalog management and model updates may execute in software. In other embodiments, these functions may reside in any combination of on-core microcode, on-die accelerators, near-die controllers, system firmware, a co-processor, or host software processes. Confidence scores and thresholds govern when to emit phase determinations or apply tuning actions, and hierarchical signatures permit identification of both phases and sub-phases. This arrangement preserves event-level fidelity and enables low-latency, real-time decisions without requiring prior knowledge of the application's codebase, and is not limited to use of a PMU or any particular deployment topology.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

What is claimed is:

1. A method of determining a phase-of-execution of code in a processing unit, comprising:
receiving, via a behavioral sensor, a sequence of behavior indicators derived from processor-level events detectable at an architectural level of the processing unit during execution of the code;
correlating the sequence of behavior indicators with profiles of stored execution phases using a phase inference engine to generate a phase determination together with an associated confidence value;
applying, by a correlation validator, a plurality of tests responsive to the phase determination or the confidence value; and
adjusting the confidence value or the phase determination based on results of the plurality of tests to reduce uncertainty.

2. The method of claim 1, wherein at least a portion of the plurality of tests applied by the correlation validator comprise controlled experiments issued by the correlation validator functioning as an experimental agent, each experiment of the controlled experiments includes a stimulus applied to hardware elements, said method measuring resulting behavior indicators from the experiment to reduce the uncertainty.

3. The method of claim 1, wherein at least a portion of the tests are active, state-changing validation tests that comprise perturbing a state of the processing unit to generate altered behavior indicators from which test results are derived, wherein results from the portion of tests that perturb the state of the processing unit are used to adjust the confidence value or the phase determination.

4. The method of claim 1, wherein at least a portion of the tests are non-intrusive tests, that evaluate consistency of the phase determination or the associated confidence value given the sequence of behavior indicators without perturbing a state of the processing unit.

5. The method of claim 1, wherein the phase determination is an inferred current phase-of-execution, for which the tests reduce uncertainty.

6. The method of claim 1, wherein the phase determination is a predicted subsequent phase-of-execution, for which the tests reduce uncertainty.

7. The method of claim 1, wherein the phase determination represents a candidate phase-of-execution among a plurality of candidates inferred by the phase inference engine, the applying comprising:
initiating one or more of the tests while the confidence value for the candidate phase is between a minimum confidence threshold and a target confidence threshold, and
iteratively repeating the applying and the adjusting to update the confidence value for the candidate phase.

8. The method of claim 7, wherein when the adjusting decreases the confidence value below the minimum confidence threshold, the candidate phase-of-execution is discarded from consideration.

9. The method of claim 7, wherein when the adjusting increases the confidence value above the target confidence threshold, the candidate phase-of-execution is selected and remaining candidate phases are discarded from consideration.

10. The method of claim 7, wherein the iteratively repeating of the applying and the adjusting continues only while a cost of performing the tests remains less than an anticipated performance benefit derived from reducing the uncertainty.

11. The method of claim 1, wherein the applying of the plurality of tests is initiated only when an expected benefit of improving confidence in the phase determination exceeds an estimated cost of performing the tests.

12. The method of claim 1, wherein the plurality of tests are organized into classes tiered according to cost, and the correlation validator initiates testing within a selected class beginning with lower-cost tests whose cumulative cost is limited relative to an anticipated benefit from reducing uncertainty.

13. A system for minimizing uncertainty when behaviorally determining a phase-of-execution, comprising:
a correlation validator configured to:
receive, from a behavioral sensor, a sequence of behavior indicators derived from processor-level events detectable at an architectural level of a processing unit during execution of code;
access phase correlation data including profiles of stored execution phases and a phase determination together with an associated confidence value generated by a phase inference engine; and
apply a plurality of tests responsive to the phase determination or the confidence value and to adjust the confidence value or the phase determination based on results of the plurality of tests to reduce uncertainty.

14. The system of claim 13, wherein the correlation validator is configured to perform active, state-changing validation tests that perturb a state of the processing unit to generate altered behavior indicators and to adjust the confidence value or the phase determination based on resulting test outcomes.

15. The system of claim 13, wherein the correlation validator is configured to initiate and iteratively repeat the applying of the plurality of tests while the confidence value is between a minimum confidence threshold and a target confidence threshold, to cease testing when the confidence value exceeds the target confidence threshold or falls below the minimum confidence threshold, and to discard a candidate phase-of-execution from consideration when the confidence value falls below the minimum confidence threshold.

16. The system of claim 13, wherein the correlation validator is configured to organize the plurality of tests into classes tiered according to cost and to initiate testing within a selected class beginning with lower-cost tests whose cumulative cost is limited relative to an anticipated benefit from reducing uncertainty.

17. The system of claim 13, further comprising:
a processing unit configured to execute code and generate processor-level events detectable at a microarchitectural level;
a behavioral sensor coupled to the processing unit and configured to detect the processor-level events and produce the sequence of behavior indicators; and
a phase inference engine coupled to the correlation validator and configured to correlate the sequence of behavior indicators with profiles of stored execution phases to generate the phase determination and the associated confidence value accessible by the correlation validator.

18. A method of predicting a subsequent phase-of-execution of code in a processing unit, comprising:
inferring, from a sequence of behavior indicators derived from processor-level execution events detectable at an architectural level of a processing unit during execution of the code, a current phase-of-execution;
predicting, based on the current phase-of-execution and the sequence of behavior indicators, a subsequent phase-of-execution together with an initial confidence value regarding the subsequent phase-of-execution;
applying, by a correlation validator, at least one of a plurality of tests that utilize at least a portion of the sequence of behavior indicators or data derived therefrom; and
responsive to results of the applied tests, adjusting the confidence value from the initial confidence value to an updated confidence value so as to reduce uncertainty in the predicting of the subsequent phase-of-execution.

19. The method of claim 18, wherein the predicting further comprises maintaining a plurality of candidate subsequent phases-of-execution, each candidate associated with a respective confidence value, and iteratively selecting or discarding the candidates based on the adjusted confidence values until one candidate exceeds a target confidence threshold.

20. The method of claim 18, wherein selecting the at least one of the plurality of tests is guided by a reinforcement-learning model trained to balance an expected confidence increase benefit against a cost of performing the test.
